(19) United States
(12) Patent Application Publication
(10) Pub. No.: US 2002/0023817 A1
(43) Pub. Date: Feb. 28, 2002

(54) Free-wheeling device

(76) Inventor: Jorg Schwarzbich, Bielefeld (DE)

Correspondence Address: Richard M. Goldberg, Suite 419, 25 East Salem Street, Hackensack, NJ, 07601, US

(21) Appl. No.: 09/943,614

(22) Filed: Aug. 30, 2001

(30) Foreign Application Priority Data
Aug. 31, 2000 (DE) 200 15 034.0

(51) Int. Cl. F16D 41/064

(52) U.S. Cl. 192/45; 192/107 T

(57) ABSTRACT

A free-wheeling device with a roll barrel (14), which is held in a cage (12), and a sleeve (10), which surrounds the cage and forms a jamming contour (16) for the roll body (14), wherein the sleeve (10) is formed from a strip (20), which originally was flat and has been bent into the hollow, cylindrical shape of the sleeve (10) and the opposite ends of, which abut one another at the seam (22) of the sleeve (10).

### FREE-WHEELING DEVICE

The invention relates to a free-wheeling device with a roll barrel, which is held in a cage, and a sleeve, which surrounds the cage and forms a jamming contour for the roll barrel.

Such a free-wheeling device is used to mount a shaft, which passes through the cage, with the help of the roll barrel in such a manner, that it can be rotated with little friction in one direction, but, when rotated in the opposite direction, is blocked relative to the sleeve. This blocking is achieved owing to the fact that, in the case of this direction of rotation, these roll barrels, which roll along the periphery of the shaft, run onto the jamming contour of the sleeve and then prevent further rotation of the shaft.

A typical example of the use of such a free-wheeling device is the rear axle of a bicycle. In addition, however, such free-wheeling devices are also used in motor vehicle technology, for example, as automatic tension-regulating element in cable pulls or also as blocking element in devices for increasing the safety in the case of a collision, for example, in the case of active head supports, which are swiveled by the inertial forces, which arise during the impact of the vehicle, into an effective position and are then blocked in the effective position self-inhibitingly by the freewheeling device. In the case of the last-named application, there is the special feature that the free-wheeling device has to carry out its function only once, namely during a collision, and can or should be destroyed by this collision, in order to consume some of the impact energy.

In the case of a conventional free-wheeling device, the sleeve consists of a steel pipe, at the inner peripheral surface of which the jamming contours for the individual roll barrels must be produced in a relatively expensive manner. The cage generally is a one-piece plastic part, which is in the shape of a peg ladder, which is closed into a ring, the barrel, such as rolls or needles being held between the individual rungs of the ladder. It is also difficult to produce this plastic part. Frequently, a spring is assigned to each needle and pre-stresses this needle elastically in the jamming direction. These springs previously were formed generally by suitably bent spring-steel strips, which must be inserted subsequently in the cage in a relatively expensive process.

It is an object of the invention to create a free-wheeling device, which can be produced at a lower cost.

Pursuant to the invention, this objective is accomplished with the distinguishing features given in the independent claims.

One distinguishing feature of the invention consists therein that the sleeve is produced from a strip, which originally was flat and was then bent into the hollow cylindrical shape of the sleeve and the opposite ends of which abut one another at the seam of the sleeve.

This solution offers the possibility of producing the jamming contours for the roll barrels in a more rational and less expensive manner by rolling or pressing the flat strip, before the latter is closed into a hollow, cylindrical sleeve. By these means, it becomes possible to lower the manufacturing costs significantly.

The hollow cylindrical shape of the sleeve can be stabilized by the cage, which is enclosed tightly by the sleeve. In may practical applications, the sleeve is pressed anyhow into a housing, so that the ends of the strip cannot be pushed apart at the seam of the sleeve, when forces, directed radially outward, act on the sleeve. If necessary, however, the tensile strength of the sleeve can be improved owing to the fact that the ends of the strip are held together by mutually complementary engaging contours.

In accordance with a further distinguishing feature of the invention, the cage consists of two separate, molded, plastic parts, which can be snapped into the sleeve from opposite ends.

This construction not only makes it possible to snap the cage more easily into the sleeve. In addition, it has the advantage that the construction of the molding tool for the cage is simplified appreciably. This is due especially to the fact that the two halves of the cage, which in each case consist of a rod and one half of the associated rungs of the “peg ladder”, can be demolded differently in the axial direction of the cage than can the conventional one-part cage.

This locking of the two halves of the cage can be accomplished in a particularly simple manner by latch cams, which are integrally molded at the cage and lock into corresponding window-like recesses in the sleeve. At the same time, by the engagement of the latch cams in the window-like recesses, the angular position of the cage in relation to the sleeve is then fixed, so that the roll barrels, held in the cage, are disposed positionally correct to the corresponding jamming contours of the sleeve.

The position of the cage relative to the sleeve can be fixed additionally owing to the fact that the outer end of each half of the cage has a ring of radially protruding cams, which engage corresponding notches at the edge of the sleeve.

Pursuant to a further distinguishing feature of the invention, the springs, which brace the individual roll barrels in the jamming direction, are integrally molded in one piece at the plastic cage, so that no additional steps are required for producing and inserting the springs in the cage.

All of these distinguishing features of the invention can be combined in a particularly advantageous manner. However, they also clearly simplify the manufacturing process and lower the manufacturing costs independently of one another.

For the combination of the above-mentioned distinguishing features, the advantageous possibility exists of forming the notches and window-like recesses of the sleeve, which are used to fix the position of the cage, as well as the engagement contours at the ends of the strip by stamping them out of the flat strip, before the latter is shaped into a hollow, cylindrical sleeve.

The original rotational symmetry of the cage is interrupted by the springs, which are integrally molded in one piece to the two halves of the cage, so that it is necessary to differentiate between a left half and right half of the cage. In order to avoid confusion during the installation, it is appropriate to produce these two halves of the cage from differently colored plastics.

In the following, an example of the invention is explained in greater detail by means of the drawings, in which

FIG. 1 shows a cross section of an inventive free-wheeling device,

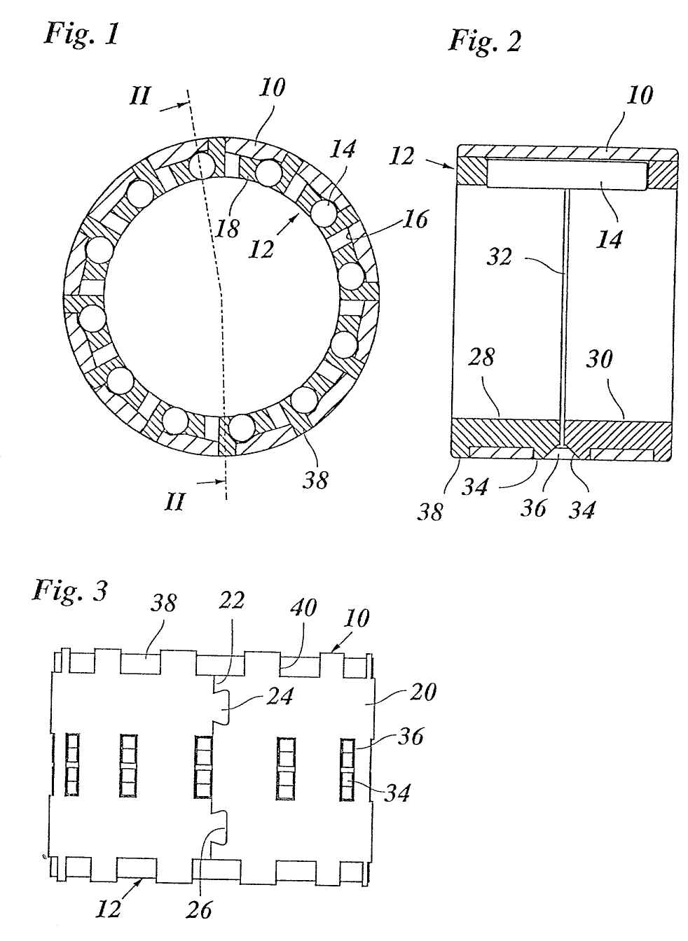

FIG. 2 shows a section through the free-wheeling device along the line II-II in FIG. 1,

FIG. 3 shows a side view of the free-wheeling device,

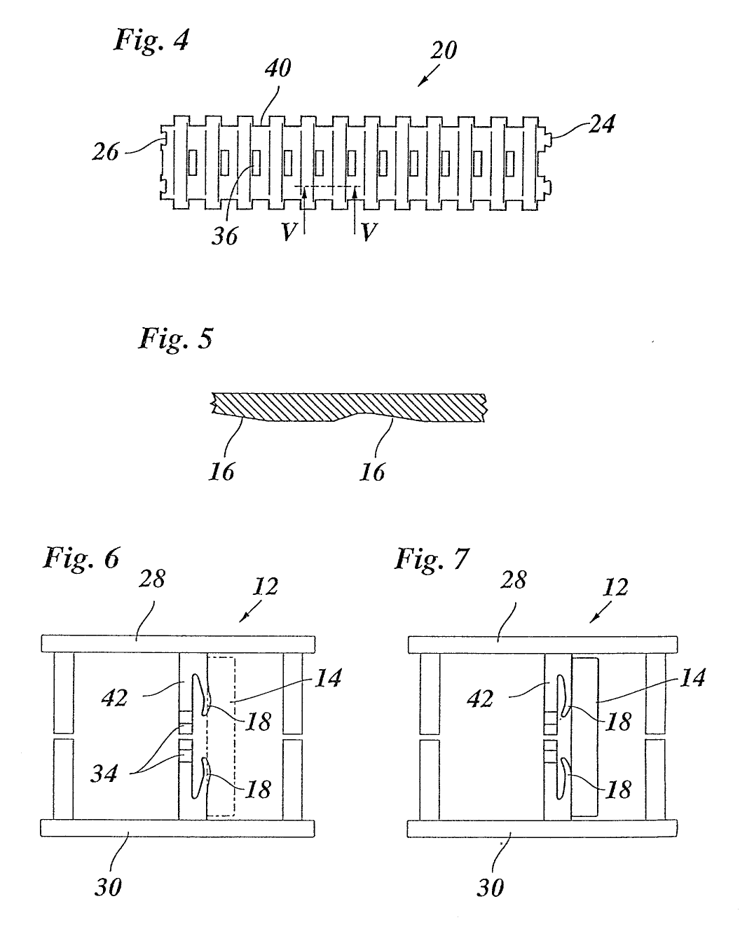

FIG. 4 shows the outline of a strip, which is bent at a later time into the sleeve of the free-wheeling device,

FIG. 5 shows an enlarged partial section along the line V-V in FIG. 4 and

FIGS. 6 and 7 show simplified representations of a cage of the free-wheeling device, which illustrate springs, which are integrally molded to the cage for bracing the roll barrels in the loaded and unloaded states.

The free-wheeling device, shown in FIGS. 1 to 3, has a hollow cylindrical sleeve 10 of hardened steel, which tightly encloses a cage 12. In the cage 12, several roll barrels are held, which are constructed as cylindrical rolls or needles 14 in the example shown. The needles 14 can roll along the outer surface of a shaft, which is not shown and extend axially through the cage 12. A ramp-like jamming contour 16, which is formed at the inner peripheral surface of the sleeve 10, is assigned to each needle 14. When the shaft, which is not shown, is rotated clockwise in FIG. 1, the needles 14 roll along the periphery of the shaft and also move in the clockwise direction, so that they run onto the ramp-like jamming contour 16 and jam between the sleeve 10 and the shaft and, in this way, block the shaft. This effect is supported owning to the fact that each needle 14 is braced in the jamming direction by springs 18, which are integrally molded in one piece to the cage 12. On the other hand, if the shaft is rotated in the counterclockwise direction in FIG. 1, it has the tendency to carry along the needles 14 in this direction counter to the force of the springs 18. The needles are then held in the region of the associated jamming contour, in which there is the greatest clearance between the shaft and the sleeve, so that there is no resistance to the rotation of the shaft relative to the sleeve 10.

As is evident from FIG. 3, the sleeve 10 is produced from a strip 20, which originally was flat and has been bent into a hollow, cylindrical body, so that the opposite ends of the strip abut one another, forming a seam 22. In this state, the ends of the strip are held together by dovetailed, mutually complementary engagement contours 24, 26.

According to FIG. 2, the cage 12 consists of two separate halves 28, 30, which are constructed as molded plastic parts and, as seem into the longitudinal direction, are separated in the center of the roller bearing by a narrow joint 32. At the inner end of each half 28, 30 of the cage, a latch cam 34 is assigned to each needle 14 of the roller bearing and the two mutually opposite latch cams 34 of the cage halves in each case engage a common window-like recesses 36 in the center of the sleeve 10. The dimensions of the joint 32 are such, that the joint enables the latch cams 34 to lock securely in the recesses 36, when the two halves 28, 30 of the cage are clipped in from opposite ends of the sleeve 10. Moreover, at the outer end opposite the joint 32, each of the two halves 28, 30 of the cage 12 has a ring of cams 38, which protrude to the outside and in each case engage an associated notch 40 at the edge of the sleeve 10. In this way, a connection, which cannot be twisted, is established between the cage 12 and the sleeve 10.

FIG. 4 shows an outline of the strip 20, before it is closed into the sleeve 10. This strip 20, to begin with, can be produced as an endless material, in which jamming contours 16 are produced, for example, by rolling and are shown on an enlarged scale in FIG. 5. In a subsequent strip, the step 20 is then stamped out from the endless material with the desired outline, the engagement contours 24, 26, the window-like recesses 36 and the notches 40 being formed at the same time. After that, the strip 20 is brought into the hollow cylindrical shape of FIG. 3 in a bending machine, the dovetail engagement contours 24 engaging complementary concave engagement contours 26, so that the ends of the strip 20 are held together firmly also when the aforementioned shaft is introduced under tension into the interior of the cage and has the tendency to expand the sleeve 10 radially. While stamping out the strip 20, it is of course necessary to take care that the recesses 36 and the notches 40 are formed in the correct position relative to the locking contours 16.

In FIGS. 6 and 7, the two halves 28, 30 of the cage 12 are in each case shown only diagrammatically. A rung 42 has been drawn with bolder lines, and half the rung being formed at half 28 and half at half 30 of the cage 12. The rung separates the seats for the two needles 14 from one another. The two latch cams 34 are also formed at this rung 42 and engage one of the window-like recesses 36 of the sleeve 10. Furthermore, one of the two springs 18, which brace the associated needle 14 in the jamming direction, is integrally molded in one piece at each half of the rung 42. FIG. 6 shows the springs 18 in the unloaded state, while FIG. 7 shows the springs 18 in elastically deformed state in contact with the associated needle 14.

1. A free-wheeling device with a roll barrel (14), which is held in a cage (12), and a sleeve (10), which surrounds the cage and forms a jamming contour (16) for the roll barrel (14), wherein the sleeve (10) is formed from a strip (20), which originally was flat and has been bent into the hollow, cylindrical shape of the sleeve (10) and the opposite ends of which abut one another at the seam (22) of the sleeve (10).

2. The free-wheeling device of claim 1, wherein the opposite ends of the strip (20) are held together by mutually complementary engagement contours (24, 26).

3. The free-wheeling device of claims 1 or 2, wherein the jamming contours (16) are produced by rolling the flat strip (20), before the latter is bent into a sleeve (10).

4. The free-wheeling device of one of the claims 1 to 3, wherein the strip (20) is a stamped-out part.

5. The free-wheeling device of the introductory portion of claim 1 or of one of the preceding claims, wherein the cage (12) is formed by two halves (28, 30), which are produced as separate molded parts and are locked into the sleeve (10) from opposite ends.

6. The free-wheeling device of claim 5, wherein the halves (28, 30) of the cage (12) carry latching cams (34), which protrude radially to the outside at mutually-facing inner ends and engage corresponding window-like recesses (36) of the sleeve (10).

7. The free-wheeling device of claim 6, wherein a pair of latching cams (34), which are formed each at one half (28, 30) of the cage and engage a common window-like recess (36) of the sleeve (10), are assigned to each roll barrel (14).

8. The free-wheeling device of one of the claims of 5 to 7, wherein the halves (28, 30) of the roller bearing (12) have several cams (38), which protrude radially to the outside at mutually opposite outer ends and engage associated notches (40) at the edge of the sleeve (10) essentially without clearance in the circumferential direction.

9. The free-wheeling device of the introductory portion of claim 1 or one of the preceding claims wherein springs (18), assigned to the individual roll barrels (14), are integrally molded in one piece from plastic to the cage (12).

10. The free-wheeling device of claims 5 and 9, wherein the roll barrels are cylindrical leader and each half (28, 30) of the cage (12) forms a spring (18) for each of the needles (14).

11. The free wheeling device of claim 10, wherein the two halves (28, 30) of the cage (12) are colored differently.
